(19) United States
(12) Patent Application Publication
(10) Pub. No.: US 2017/0102834 A1
(43) Pub. Date: Apr. 13, 2017

(54) ASYNCHRONOUS SURVEY DATA COLLECTION THROUGH MOBILE DEVICES

(71) Applicant: SoukTel, Inc., Newark, DE (US)

(72) Inventor: Michael Moszczynski, Toronto (CA)

(21) Appl. No.: 14/879,773

(22) Filed: Oct. 9, 2015

(51) Int. Cl. G06F 3/0482; G06Q 30/02; G06F 3/0484

(52) U.S. Cl. CPC G06F 3/0482; G06F 3/04842; G06Q 30/0203

(57) ABSTRACT

Survey data collection using a mobile device over an asynchronous messaging system is provided. According to one embodiment, a question descriptor is received via a network. The question descriptor includes a user prompt and a response specification. At least one user interface element is selected. The user interface element is adapted to receive a response complying with the response specification. The user prompt is displayed on a display. The at least one user interface element is displayed on the display. A response is received from a user via the user interface element. The response complies with the response specification. A response descriptor is sent via the network. The response descriptor includes the response.

### BACKGROUND

Embodiments of the present invention relate to survey data collection, and more specifically, to survey data collection using a mobile device over an asynchronous messaging system.

### BRIEF SUMMARY

According to one embodiment of the present invention, a method of, system for, and computer program product for survey data collection are provided. A question descriptor is received via a network. The question descriptor includes a user prompt and a response specification. At least one user interface element is selected. The user interface element is adapted to receive a response complying with the response specification. The user prompt is displayed on a display. The at least one user interface element is displayed on the display. A response is received from a user via the user interface element. The response complies with the response specification. A response descriptor is sent via the network. The response descriptor includes the response.

### BRIEF DESCRIPTION OF THE SEVERAL VIEWS OF THE DRAWINGS

FIG. 1 depicts an exemplary system according to embodiments of the present disclosure.

FIG. 2 depicts an exemplary messaging exchange via a short messaging service.

FIG. 3 depicts a survey data collection process according to embodiments of the present disclosure.

FIG. 4 depicts a survey distribution process according to embodiments of the present disclosure.

FIGS. 5A-5F depict exemplary input screens according to embodiments of the present disclosure.

FIG. 6 depicts a computing node according to an embodiment of the present invention.

### DETAILED DESCRIPTION

In regions with limited or damaged infrastructure, collecting data such as survey responses from the field may be difficult or impossible. Intermittent power and network connectivity frequently preclude the use of phone calls or web applications. Travel conditions may likewise preclude in-person data collection, which is expensive even when possible. In many developing regions, cellular phone adoption is high. For example, the Pew Research Center Spring 2013 Global Attitudes survey showed a median of 83% cellular phone ownership among 24 emerging and developing economies. However, the vast majority of these phones are not smartphones, and lack robust internet connectivity and web browsing capabilities.

Short Message Service (SMS) is available as part of all major cellular standards, and allows a short text message to be delivered to a mobile handset. SMS may be implemented for a variety of different handsets in a variety of different wireless communication systems including those based on GSM and CDMA. For illustrative purposes, various examples provided herein discuss cellular phones on cellular networks. However, it will be apparent to one of skill in the art that the systems and methods disclosed herein are suitable for other messaging platforms such as paging networks, packet radios and satellite phones.

Although SMS is available on many mobile handsets without the need for a smartphone, message delivery is not necessarily reliable. In particular, an intermittently connected mobile device may receive SMS message out of order or not at all. In addition, latency may be so high as to make a real time conversation difficult or impossible.

According to various embodiments of the present disclosure, systems, methods, and mobile devices are provided that enable data collection from a user without requiring an Internet connection to send or receive data. A set of survey questions is packaged into a single descriptor, generated by a message handler remote from the mobile device. The descriptor is sent to the mobile device in an SMS message. The descriptor is processed automatically by the mobile device into a dynamically generated visual interface, which is then displayed to the user. The user then completes the survey visually, and at completion the responses are packaged and compressed into a single SMS message and sent from the device to a remote message handler. There is no user-perceptible network delay and as little as one message is sent in each direction. Where the descriptor exceeds a size limit imposed on messages by the underlying network infrastructure (e.g., 160 characters for an SMS message), the descriptor may be split among multiple messages.

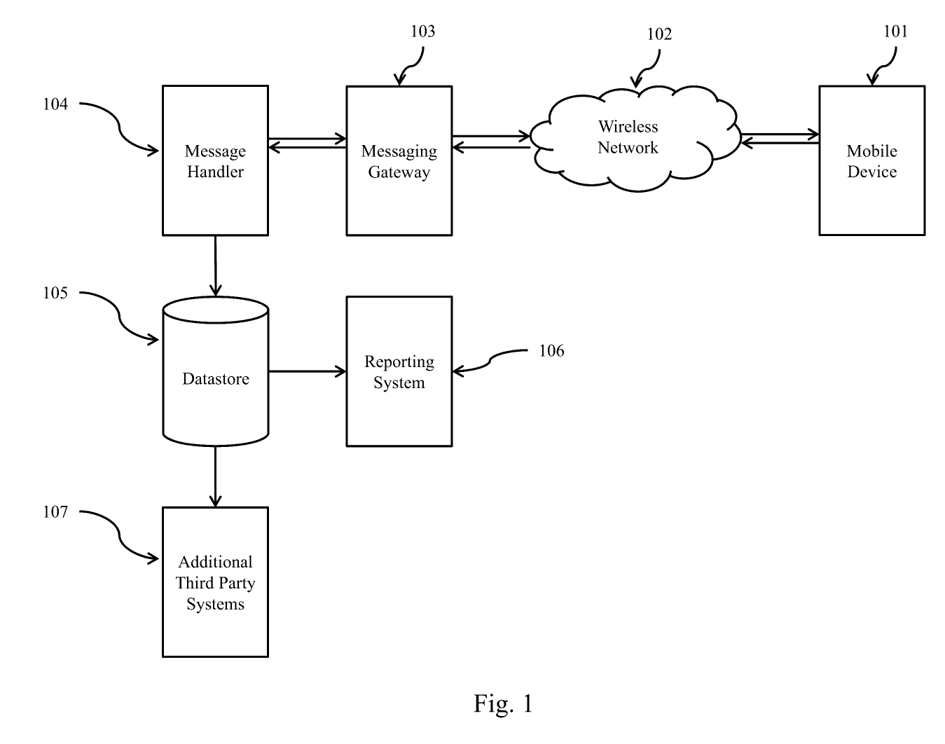

With reference now to FIG. 1, an exemplary system is depicted for asynchronous survey data collection through mobile devices according to various embodiments of the present disclosure. At least one mobile device 101 is connected via a wireless network 102 to a messaging gateway 103. In some embodiments, mobile device 101 is a cellular phone, and wireless network 102 is a cellular network. In some such embodiments, messaging gateway 103 is an SMS gateway. In other embodiments, wireless network 102 is a paging network and mobile device 101 is a pager. It will be apparent that a variety of mobile devices and wireless infrastructure are suitable for use according to the present disclosure.

Message handler 104 is operably connected to messaging gateway 103, such as over a LAN, a WAN, or the Internet. Messaging handler 104 sends and receives messages to mobile device 101 as set forth below, via wireless network 102. Upon receipt of survey results as set forth below, message 104 handler reassembles any partial messages, and stores the results in datastore 105. Datastore 105 may be a flat file, a relational database, or other datastore known in the art. Reporting system 106 may access datastore 105 to generate summary data, visualizations, and statistics based on the survey results stored in datastore 105. Likewise, additional third party systems 107 may access datastore 105 in order to provide additional analysis of the survey results stored in datastore 105. In various embodiments, each of message handler 104, messaging gateway 103, and datastore 105 are resident in separate computing nodes, in a single computing node, or deployed across any number of computing nodes in a cloud or distributed arrangement.

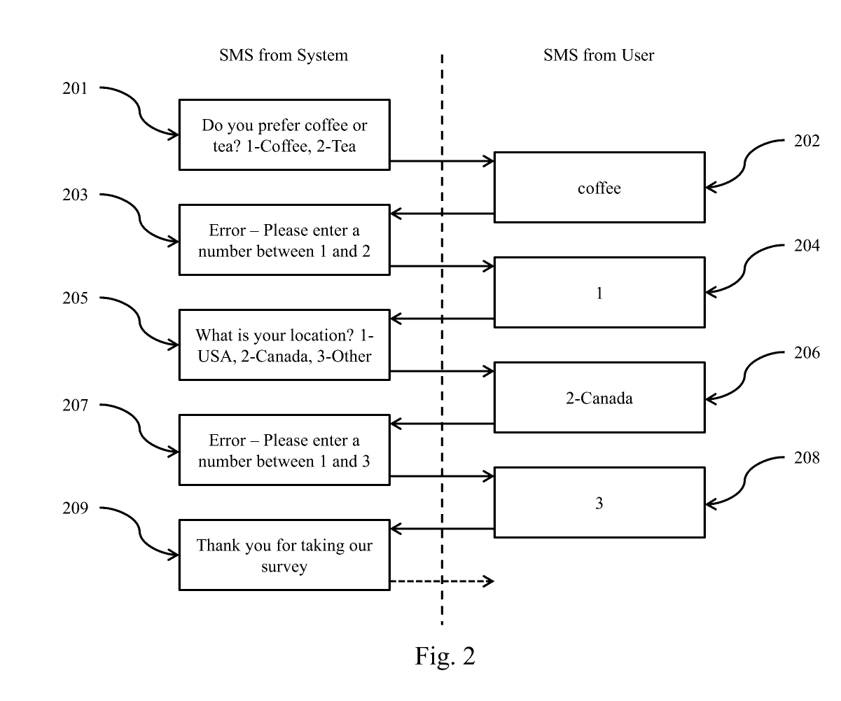

In order to collect data from remote locations with limited infrastructure, SMS may be used. For example, a conversation may be initiated with a remote user to ask questions. This process may be manual, relying on an operator to query a user and collect responses, or may be automated. Such an automated approach is illustrated in FIG. 2. A first question 201 in sent by SMS to a user. A response 202 is received. In this exemplary exchange, response 202 does not conform to the expected format, so an error 203 is transmitted to the user. A new response 204 is sent by the user. A second question 205 is sent to the user. The response 206 again does not confirm to the expected format. Accordingly, a second error 207 is generated and sent to the user. The user provides a properly formatted response 208. Finally, a survey completion message 209 is sent to the user.

As may be seen from the exemplary sequence of FIG. 2, sending individual survey questions to a user may result in a lengthy exchange. Particularly in regions where cellular service is slow or intermittent, the exemplary exchange of FIG. 2 may be spread over several hours. Moreover, in instances where per-message fees are assessed by a wireless provider, such an exchange may be cost-prohibitive. Where SMS is provided via a built-in messaging application, input validation may be unavailable, leading to input errors by the user. As illustrated, input errors on the part of the user lead to proliferation of messages, which in turn may results in additional costs to the user or to the survey initiator. These potential complications may lead to a reduction in completion rates—the longer that an exchange takes, or the more it costs, the less likely a given user is to complete an entire survey.

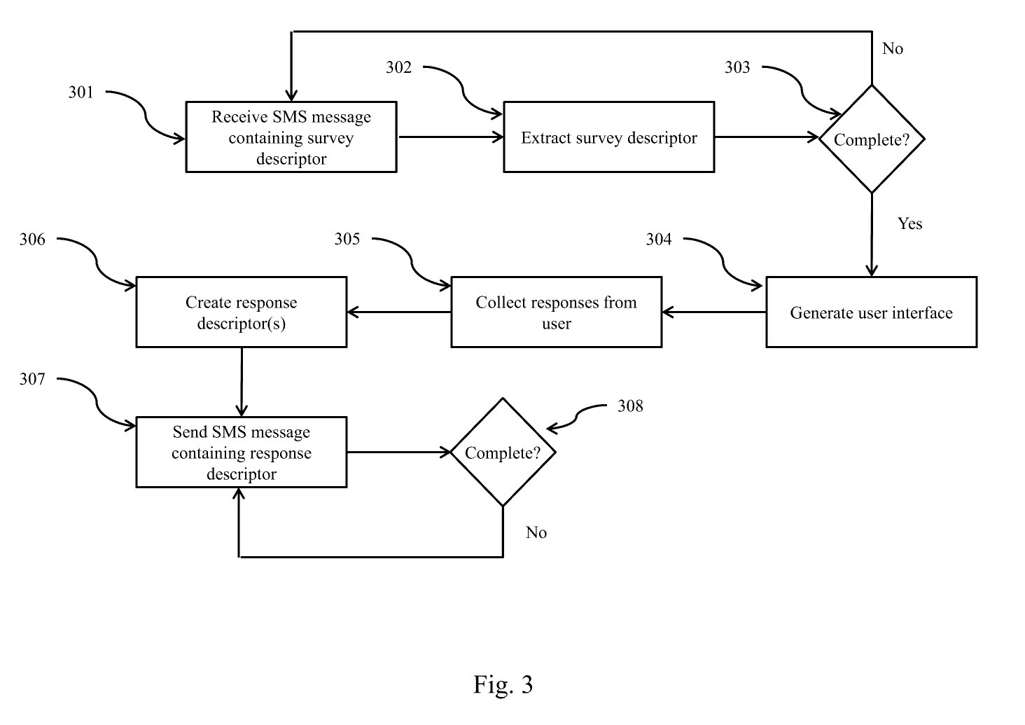

Referring now to FIG. 3, a data collection process according to embodiments of the present disclosure is illustrated. At 301, an SMS message is received at a mobile device. A survey descriptor is extracted 302 from the SMS message. In some embodiments, extraction includes decompression of the message contents. In some embodiments, extraction includes decoding a survey descriptor based on a predetermined encoding scheme. In some embodiments, an entire survey is contained in one survey descriptor in one SMS message. In other embodiments, multiple survey descriptors are received in multiple SMS messages. In such embodiments, the SMS message may include a sequence number and a message count, enabling the mobile device to store the survey descriptors and determine whether it has received all survey descriptors. If the survey descriptors are not complete 303, additional SMS messages are received. If the survey descriptors are complete, then a user interface is generated 304 on the mobile device. In some embodiments, the user interface is a graphical user interface (GUI). In some embodiments, a text based user interface is generated instead.

Through the generated user interface, responses are collected 305 from the mobile device user. A response descriptor is generated 306 from the user responses. In some embodiments, generating the response descriptor includes compressing the user responses. In some embodiments, generating the response descriptor includes encoding the user responses according to a predetermined encoding scheme. In case the descriptor would exceed a platform specific message size limit (e.g., 160 characters for an SMS message), multiple descriptors are generated. The response descriptor is sent 307 via SMS. If sending is not complete 308, for example, because more than one descriptor was generated, additional SMS messages are sent.

In some embodiments, upon receipt of an SMS message that forms a portion of a survey descriptor, the message is retained for a predetermined period of time or until all portions of the survey descriptor are received. If all portions are not received within the predetermined period, a request that portions be resent may be sent from the mobile device. In some embodiments, a request for all portions is sent. In other embodiments, a request for only missing portions is sent.

In exemplary embodiments, the survey descriptor comprises an identifier and a plurality of question descriptors. In some embodiments, the descriptor includes a survey title. In some embodiments, the descriptor includes a sequence number and a descriptor count. In such embodiments, the descriptor count provides the total number of descriptors and the sequence number uniquely identified each descriptor in the sequence. In this way, a survey can be subdivided into multiple messages, which are then numbered in sequence. An exemplary survey descriptor is provided below in Table 1. A predetermined value “@%” appears at the beginning of the descriptor in order to identify it as a survey descriptor. Following the identifier, one byte is reserved for the sequence number, and one byte is reserved for the descriptor count.

TABLE 1

| Bytes | Value | Description |
|---|---|---|
| 0x00 . . . 0x01 | @% | Survey descriptor identifier |
| 0x02 | 0x02 | Message sequence |
| 0x03 | 0x04 | Total messages in sequence |
| 0x05 . . . | . . . | Question descriptor 1 |
| . . . | . . . | Question descriptor 2 |
| . . . | . . . | Question descriptor 3 |

Each survey descriptor may contain an arbitrary number of question descriptors. Each question descriptor includes an indication of the question type, any question text, and any response options for the question. An exemplary question descriptor is provided below in Table 2. This question descriptor begins with two bytes indicating the length of the question descriptor. This is followed by a byte indicating the question type, selected from a predetermined set of question types, such as those enumerated below in Table 3. This is followed by the question text, terminated with a 0 byte. This is optionally followed by a set of options separated by the 0 byte (in the case of multiple-choice questions) or a maximum/minimum range of possible answers (in the case of date or integer questions). Each question descriptor can have an arbitrary number of options. In some embodiments, the descriptor includes a sequence number and a descriptor count. In such embodiments, the descriptor count provides the total number of descriptors and the sequence number uniquely identified each descriptor in the sequence. In this way, a question can be subdivided into multiple messages, which are then numbered in sequence.

TABLE 2

| Bytes | Value | Description |
|---|---|---|
| 0x00 . . . 0x01 | 0x00 26 | Length of question descriptor |
| 0x02 | 0x03 | Question-type |
| 0x03 | 0x04 | Message sequence |
| 0x04 | 0x04 | Total messages in sequence |
| 0x05 . . . 0x1a | Do you prefer coffee | Question text |
| | or tea? 0x00 | |
| 0x1b . . . 0x1f | Coffee 0x00 | Option 1 |
| 0x20 . . . 0x27 | Tea 0x00 | Option 2 |

As noted above, a question descriptor makes reference to a question type. Exemplary question types and corresponding integer values are provided below in Table 3. Various additional embodiments include additional question types, including but not limited to license plate, government ID, social security number, credit card number, altitude, phone number, blood type, birth year, QR code, or barcode. In some embodiments, the question type includes additional input validation information. For example, in some embodiments, the question type includes a regular expression that is applied upon user input to determine whether an input matches the expected format. In other embodiments, the question type includes checksum information that is used to validate an input that includes a checksum. For example, the Luhn algorithm may be applied to validate a credit card number.

TABLE 3

| # | Type | Description |
|---|---|---|
| 1 | Multiple | User is given a list of options, from which |
| | Choice | one is chosen |
| 2 | Text | User is given a text entry field to enter any text |
| 3 | Yes/No | User is given two buttons, yes and no. |
| 4 | Integer | User is given an integer selector with a |
| | | specified range |
| 5 | Date | User is given a calendar control with a |
| | | specified range |
| 6 | Location | User is asked to use the device GPS function |
| | | to provide a location, if available |

In exemplary embodiments, the response descriptor comprises an identifier and a plurality of responses. In some embodiments, the descriptor includes a sequence number and a descriptor count. In such embodiments, the descriptor count provides the total number of descriptors and the sequence number uniquely identified each descriptor in the sequence. In this way, a survey response can be subdivided into multiple messages, which are then numbered in sequence. An exemplary response descriptor is provided below in Table 4. A predetermined value “@%” appears at the beginning of the descriptor in order to identify it as a response descriptor. Following the identifier, one byte is reserved for the sequence number, and one byte is reserved for the descriptor count.

TABLE 4

| Bytes | Value | Description |
|---|---|---|
| 00 . . . 01 | @% | Response descriptor identifier |
| 02 | 0x02 | Message sequence |
| 03 | 0x04 | Total messages in sequence |
| 04 . . . 05 | 0x02 00 | Response indicating option 2 |
| 06 . . . 0a | Mike 0x00 | Response indicating text ‘Mike’ |
| 0b . . . 0f | 0x55 A6 23 B3 00 | Response indicating a Unix Hex |
| | | timestamp |

In the above descriptors, integer values are encoded as bytes and variable length values are separated by 0 bytes. However, it will be appreciated that alternative encoding schemes can be applied according to embodiments of the present disclosure. For example, some embodiments provide the descriptors as XML documents. In some embodiments, the descriptor is encoded in Base64 prior to sending. In some embodiments, the descriptor is compressed using one of various compression algorithms known in the art.

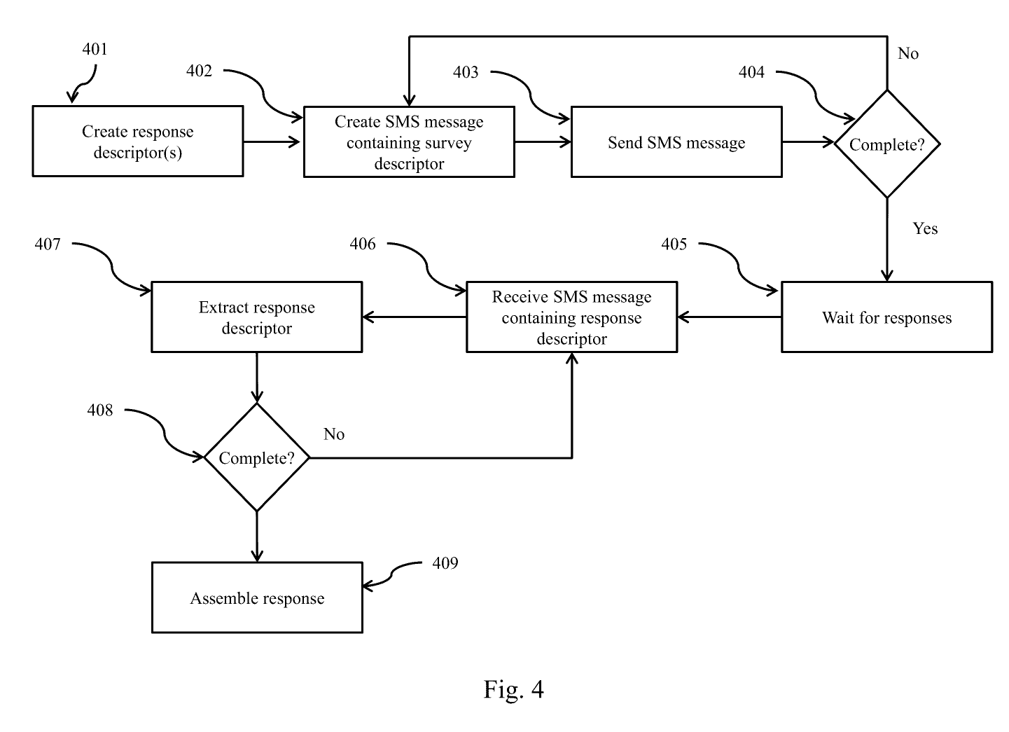

Turning now to FIG. 4, a survey distribution process according to embodiments of the present disclosure is depicted. At 401, a survey descriptor is generated. As discussed above, in case the descriptor would exceed a platform specific message size limit (e.g., 160 characters for an SMS message), multiple descriptors are generated. An SMS message is created 402 containing the survey descriptor. The SMS message is sent 403. If sending is not complete 404, additional messages are sent. Responses are awaited 405. In some embodiments, waiting may be for a predetermined period. In some embodiments, once a predetermined period elapses without a response, the survey descriptors are resent. Upon receipt 406 of an SMS message, a response descriptor is extracted 407 from the message. Based on the sequence number as described above, it is determined whether the response is complete 408. If it is not complete, the descriptor is stored and additional messages are received. If receipt of descriptors in complete, they are assembled 409 to form a complete response. In some embodiments, the response is then stored in a datastore such as datastore 105, above.

In some embodiments, upon receiving a survey descriptor, the user of a mobile device receives a notification indicating that there is a survey available for completion. Upon activating this notification, the survey is initiated. In some embodiments, a user may launch an application through a platform-specific mechanism such as a shortcut icon. The application displays a list of all surveys available for completion. The user may complete those that have not yet been completed, or review the answers for those that were completed in the past. Some surveys may be submitted more than once depending on the survey parameters.

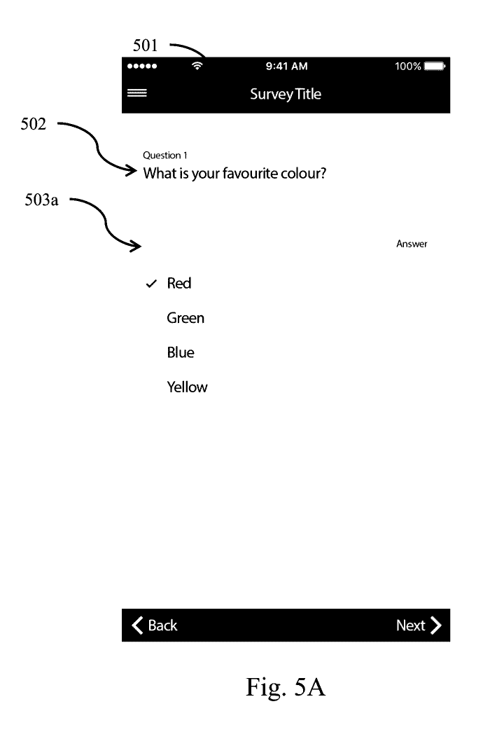

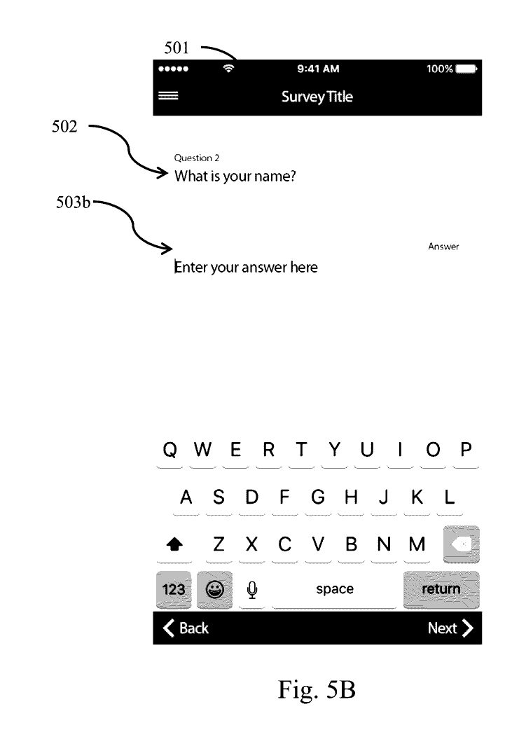

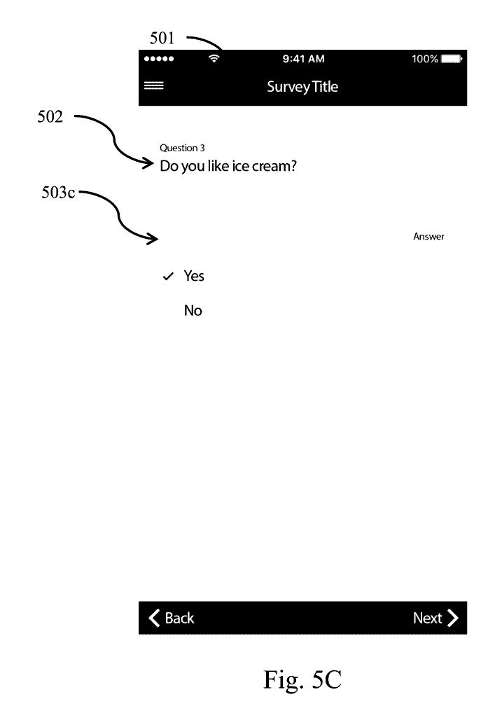

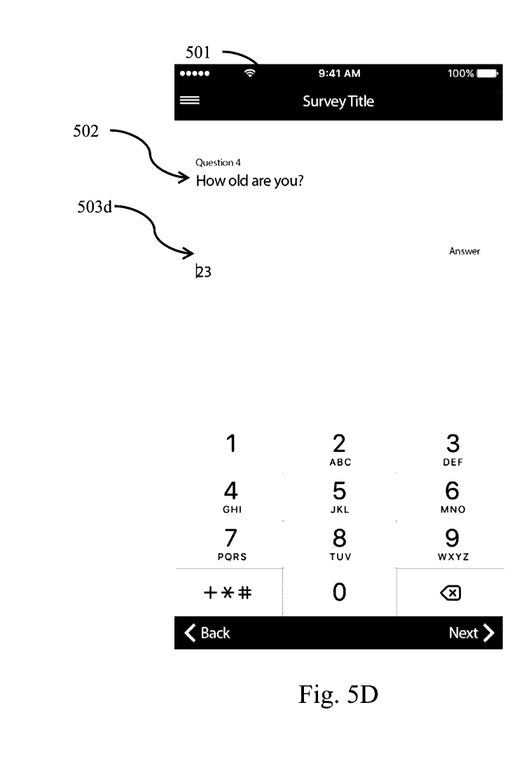

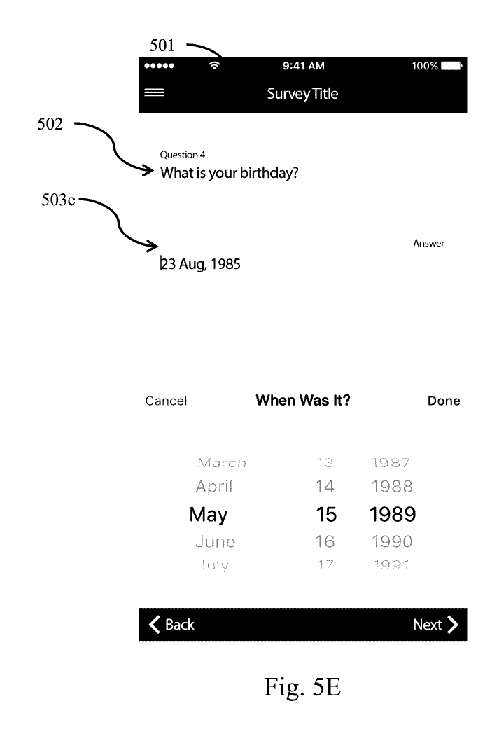

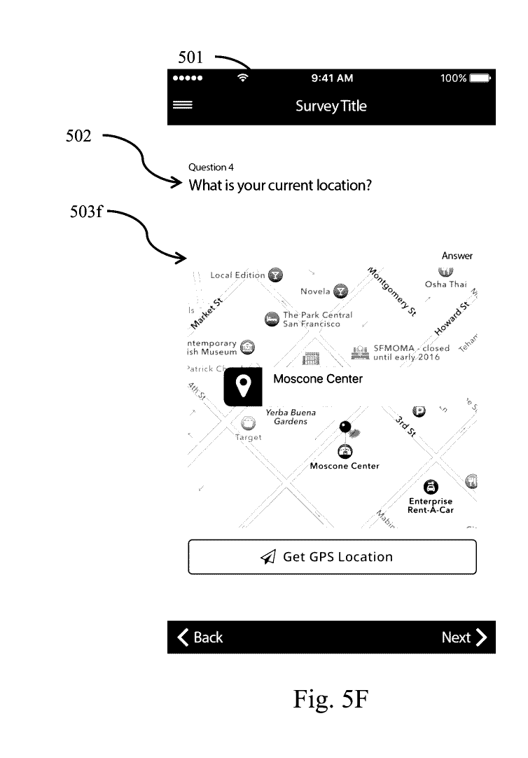

Referring now to FIGS. 5A-5F, exemplary input screens are provided for each of the questions types of Table 3. Survey title 501 is displayed on input screen 500. Question 502 correspond to the question text contained in the question descriptors as discussed above. Answer area 503 is generated based on the question type as discussed above. As may be seen, platform-specific user interface elements are displayed for the input of data according to the question type. Accordingly, the user interface elements depicted are exemplary—alternative user interface toolkits and platforms may use different input elements. As pictured, a multiple choice field 503a corresponds to a multiple choice question type. In some embodiments, a series of buttons, a combo box, or radio buttons are used to select one of several values. Text area 503b corresponds to a text question type. A multiple choice field 503c corresponds to the yes/no question type. In some embodiments, a series of buttons, a combo box, or radio buttons are used to select one of several values. Numeric input pad 503d corresponds to the integer question type. In some embodiments, a series of buttons, a number wheel, or a slider are used to select a numeric value. Calendar wheel 503e corresponds to the date question type. In some embodiments, a calendar widget or a series of comboboxes are used to select a date value. Map 503f corresponds to the location question type.

In some embodiments, upon completion of all of the questions in a survey, the user is shown a screen detailing all answers and asking to submit the completed survey. One the user indicates that the survey results should be submitted, the responses are packaged into a response descriptor and sent as discussed above. The recipient will be the number from which the survey descriptor was received.

In some embodiments, the survey descriptors further include an answer to each question. Using this answer, a quiz is provided to the user of a mobile device. After the user has entered an answer, it is compared to the answer included in the survey descriptor. In some embodiments, a score is computed based on the number of questions answered correctly. In some embodiments, the user is presented with a final score after completing all questions in the survey. In other embodiments, the user is provided with immediate feedback regarding the correctness of the answer. In some embodiments, feedback is configured by inclusion of additional fields in the survey descriptor.

In some embodiments, the mobile device maintains a log of all surveys received and all surveys completed. The log is accessible to the user on the device, and may be browsed by a mobile device user. In such embodiments, the user may select an incomplete survey for completion. In some embodiments, each survey descriptor includes an indication of whether it can be completed more than once. In such embodiments, the mobile device application will preclude a user from completing a given survey again where indicated.

In some embodiments, the survey descriptor further supports branching. In such embodiments, the questions presented to the user depend on the answer to prior questions. The survey descriptor further includes a sequence number for each question. In the case of multiple choice and yes/no questions, the sequence number of a next question is identified with the options available for response. In the case of numeric questions, a range of numbers is provided in the question descriptor, which is in turn associated with the sequence number of the question to which it leads. In this manner, complex branching logic and answer-dependent questions may be defined.

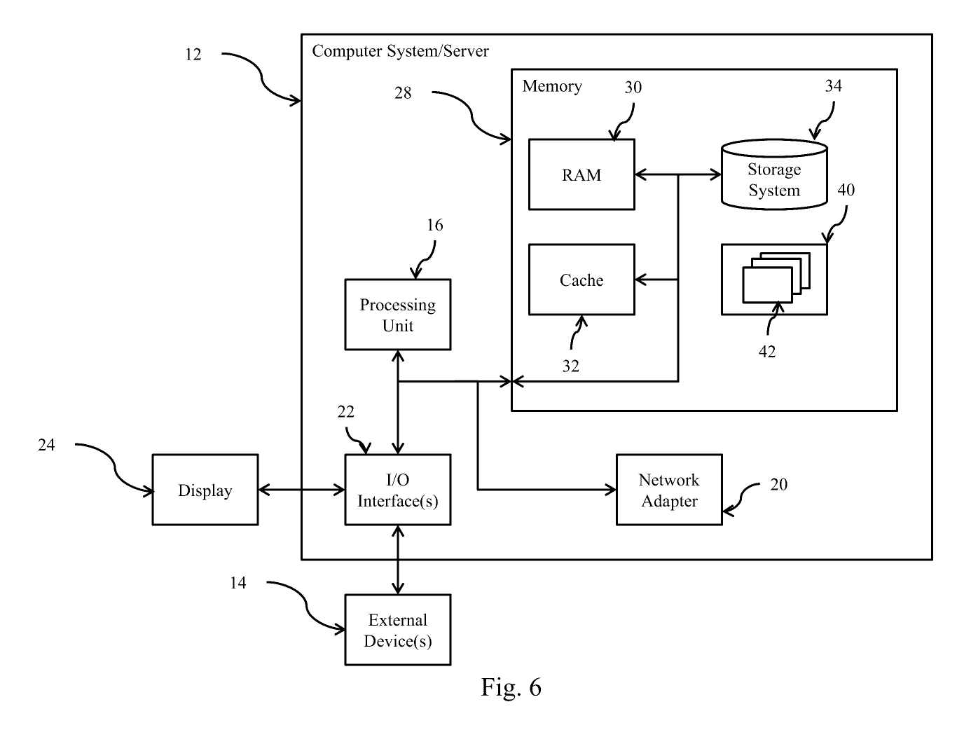

Referring now to FIG. 6, a schematic of an example of a computing node is shown. Computing node 10 is only one example of a suitable computing node and is not intended to suggest any limitation as to the scope of use or functionality of embodiments of the invention described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 6, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
receiving via a network a question descriptor, the question descriptor comprising a user prompt and a response specification;
selecting at least one user interface element adapted to receive a response complying with the response specification;
displaying the user prompt on a display;
displaying the at least one user interface element on the display;
receiving a response from a user via the user interface element, the response complying with the response specification;
sending via the network a response descriptor, the response descriptor comprising the response.

2. The method of claim 1, wherein receiving the question descriptor comprises:
receiving a survey descriptor comprising the question descriptor; and
extracting the question descriptor from the survey descriptor.

3. The method of claim 2, wherein the survey descriptor comprises a plurality of additional question descriptors.

4. The method of claim 3, wherein each of the plurality of additional question descriptors comprises a user prompt and a response specification, the method further comprising:
selecting a plurality of additional user interface elements adapted to receive responses complying with the response specifications of the plurality of additional question descriptors;
displaying the user prompts of the plurality of additional question descriptors on a display;
displaying the plurality of additional user interface elements on the display;
receiving a plurality of additional responses from a user via the plurality of additional user interface elements.

5. The method of claim 4, wherein the response descriptor further comprises the plurality of additional responses.

6. The method of claim 4, further comprising:
sending via the network an additional response descriptor, the additional response descriptor comprising the plurality of additional responses.

7. The method of claim 2, wherein extracting the question descriptor comprises decoding the survey descriptor.

8. The method of claim 2, wherein extracting the question descriptor comprises decompressing the survey descriptor.

9. The method of claim 1, wherein the network is a cellular network.

10. The method of claim 9, wherein receiving the question descriptor comprises:
receiving an SMS message, the SMS message comprising the question descriptor.

11. The method of claim 9, wherein sending the response descriptor comprises:
sending an SMS message, the SMS message comprising the response descriptor.

12. The method of claim 2, further comprising:
determining from the survey descriptor that at least one additional survey descriptor is expected;
waiting to receive the at least one additional survey descriptor prior to displaying the at least one user interface element on the display.

13. The method of claim 1, wherein the response specification comprises a plurality of compliant options.

14. The method of claim 1, wherein the response specification comprises a compliant numeric range.

15. The method of claim 1, wherein the response specification comprises a type selected from the group consisting of date, time, location, integer, number, text, and boolean.

16. A system comprising:
a display;
a user input device;
a network adapter;
a processor, wherein the processor executes instructions to:
receive via the network adapter a question descriptor, the question descriptor comprising a user prompt and a response specification;
select at least one user interface element adapted to receive a response complying with the response specification;
display the user prompt on the display;
display the at least one user interface element on the display;
receive a response from a user via the user input device, the response complying with the response specification;
send via the network adapter a response descriptor, the response descriptor comprising the response.

17. A computer program product for survey data collection, the computer program product comprising a computer readable storage medium having program instructions embodied therewith, the program instructions executable by a processor to cause the processor to perform a method comprising:
receiving via a network a question descriptor, the question descriptor comprising a user prompt and a response specification;
selecting at least one user interface element adapted to receive a response complying with the response specification;
displaying the user prompt on a display;
displaying the at least one user interface element on the display;
receiving a response from a user via the user interface element, the response complying with the response specification;
sending via the network a response descriptor, the response descriptor comprising the response.
